(19) United States
(12) Patent Application Publication
(10) Pub. No.: US 2023/0278467 A1
(43) Pub. Date: Sep. 7, 2023

(54) OCCUPANT SENSING SYSTEM AND SEAT ADJUSTMENT SYSTEM

(71) Applicant: Biologue Co., Ltd., Taipei (TW)

(72) Inventors: Sheng-Chi KAO, Taipei (TW); Chia-Yu YU, Taipei (TW); Ching-Feng CHENG, Taipei (TW); Pin-Xian WU, Taipei (TW)

(21) Appl. No.: 18/194,048

(22) Filed: Mar. 31, 2023

Related U.S. Application Data
(63) Continuation-in-part of application No. 17/008,602, filed on Aug. 31, 2020, now Pat. No. 11,648,853.
(60) Provisional application No. 63/036,452, filed on Jun. 9, 2020.

(51) Int. Cl. B60N 2/00; B60N 2/90

(52) U.S. Cl. CPC B60N 2/002; B60N 2/90; B60N 2002/981

(57) ABSTRACT

An occupant sensing system is provided. The seat adjustment system includes at least one first sensor, at least one second sensor, and a computer system. The first sensor is configured to obtain at least one physiological signal of an occupant. The second sensor is configured to obtain at least one environmental signal that does not contain the at least one physiological signal of the occupant. The computer system is connected to the at least one first sensor and the at least one second sensor, the computer system receives the at least one physiological signal and the at least one environmental signal, and the computer system includes in a fatigue reminder computation an environmental auxiliary parameter generated by performing a feature extraction of the at least one physiological signal and the at least one environmental signal.

### CROSS-REFERENCE

This application is a continuation-in-part of U.S. Pat. Application No. 17/008,602 filed on Aug. 31, 2020, which claims the benefit of U.S. Provisional Application No. 63/036,452, filed on Jun. 9, 2020. Each of the above-referenced patent applications is herein incorporated by reference in its entirety.

### FIELD OF THE INVENTION

The present invention relates to a seat adjustment system and occupant sensing system for a vehicle seat, and more particularly, to a seat adjustment system and occupant sensing system capable of providing an occupant with more comfortable and healthy seating experience to achieve better safety protection and user experience.

### BACKGROUND OF THE INVENTION

Fatigue warning is to evaluate a driving state and continuously monitor the driving state to give a warning when fatigue occurs. At present, fatigue warning includes mainly indirect and direct modes. The indirect mode is to reflect the reaction speed and attention degree of a driver through the interaction of the driver with the control keys in a vehicle, and then determine whether the driver is fatigued; the direct mode is to determine whether the driver is fatigued by observing the physiological state of the driver. The direct mode is popular now, and various implementations of the direct mode can be classified as non-contact and contact modes. The non-contact mode is the popular one, by which whether the driver is fatigued is determined by observing the activities of the eyes, head, or other upper limbs of the driver through a camera module. The contact mode is to detect physiological conditions by contact sensing devices provided on a steering wheel or vehicle seat, such as those implemented on the vehicle seat disclosed in U.S. Pat. Publication Nos. US 2015/0008710 A and US 2018/0304774 A1.

However, the above-mentioned non-contact camera module-based detection method has a problem of failure of the camera module due to human or environmental factors. However, the embodiment disclosed in US2015/0008710A suffers from a problem that the contact mode implemented on the vehicle seat may be interfered with by a complex environment in the vehicle, which leads to less reliable detection.

### SUMMARY OF THE INVENTION

In view of the above, it is a primary object of the application to provide an occupant sensing system that solve and mitigate external environmental interferences.

An occupant sensing system for a vehicle seat is provided. The occupant sensing system includes at least one first sensor, at least one second sensor, and a computer system. The at least one first sensor is disposed in the vehicle seat to obtain at least one physiological signal of an occupant, and the at least one second sensor is disposed in the vehicle seat to obtain at least one environmental signal that does not contain the at least one physiological signal of the occupant. The computer system is connected to the at least one first sensor and the at least one second sensor, the computer system receiving the at least one physiological signal and the at least one environmental signal, and an environmental auxiliary parameter, generated by performing a feature extraction of the at least one physiological signal and the at least one environmental signal, is considered in a fatigue reminder computation by the computer system.

In an embodiment, the computer system generates the environmental ancillary parameter through performing a feature projection, a feature analysis, and a correlation analysis of the at least one physiological signal and the at least one environmental signal.

In an embodiment, the computer system generates an environmental signal feature set and a physiological signal feature set when the feature projection ends, the environmental signal feature set and the physiological signal feature set are considered in the feature analysis and the correlation analysis.

In an embodiment, the computer system determines whether to perform a feature optimization program through computing an analysis between the environmental auxiliary parameter and the physiological signal feature set, the feature optimization program updating at least one of the environmental signal feature set and the physiological signal feature set.

In an embodiment, the computer system generates at least one physiological information through performing a feature mixing of the physiological signal feature set, and the environmental auxiliary parameter is used to determine the reliability of the at least one physiological information.

In an embodiment, the computer system performs a physiological individual learning based on the at least one physiological information generated at different times, and results of the physiological individual learning are considered in the fatigue reminder computation.

In an embodiment, the occupant sensing system further comprises at least one output unit connected to the computer system to operate based on results of the fatigue reminder computation.

The invention provides a seat adjustment system including a seat body, an occupant sensing system, at least one actuating unit, and a control unit. The occupant sensing system is as described above. The at least one actuating unit adjusts support of the seat body. The control unit is connected to the occupant sensing system and the at least one actuating unit, and the control unit controls the at least one actuating unit based on a fatigue reminder computation performed by the occupant sensing system.

Given the foregoing, the invention is more advantageous than the conventional technique in that the computer system according to the environmental auxiliary parameter, generated by performing the feature extraction of the at least one physiological signal and the at least one environmental signal, is considered in the fatigue reminder computation, which specifically solves the problem of low reliability of a result of contact sensing caused by a complex environment of a vehicle, and increase accuracy of the result of contact sensing.

### BRIEF DESCRIPTION OF THE DRAWINGS

FIG. 1 is a schematic diagram of a seat adjustment system according to an embodiment of the present invention.

FIG. 2 is a schematic diagram of operations of the seat adjustment system shown in FIG. 1 according to an embodiment of the present invention.

FIG. 3 is a flowchart of operations of the seat adjustment system shown in FIG. 1 according to an embodiment of the present invention.

FIG. 4 is an exploded view of the seat adjustment system shown in FIG. 1 according to an embodiment of the present invention.

FIG. 5 and FIG. 6 are schematic diagrams of a seat adjustment system according to another embodiment of the present invention.

FIG. 7 is a flowchart of operations of the seat adjustment system shown in FIG. 5 and FIG. 6 according to an embodiment of the present invention.

FIG. 8 is a schematic diagram of operations of the occupant sensing system according to an embodiment of the present invention.

FIG. 9 is a schematic diagram of operations of the computer system according to an embodiment of the present invention.

FIG. 10 is a schematic diagram of another occupant sensing system according to an embodiment of the present invention.

FIG. 11 is a schematic diagram of an implementation of a fatigue reminder computation by the computer system according to an embodiment of the present invention.

FIG. 12 is a schematic diagram of an implementation of the computer system performing a feature extraction of signals according to an embodiment of the present invention.

FIG. 13 is a schematic diagram of an implementation of the computer system performing the feature extraction of signals according to another embodiment of the present invention.

FIG. 14 is a schematic diagram of an implementation of the computer system performing feature optimization of signals according to an embodiment of the present invention.

FIG. 15 is a schematic diagram of an implementation of the computer system performing a physiological information computation according to an embodiment of the present invention.

FIG. 16 is a schematic diagram of an implementation of the computer system performing a fatigue computation according to another embodiment of the present invention.

### DETAILED DESCRIPTION OF THE PREFERRED EMBODIMENTS

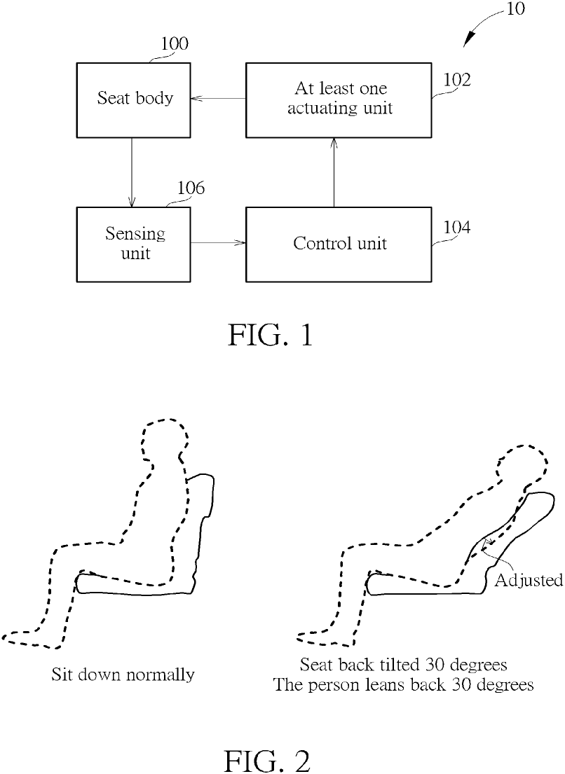

Please refer to FIG. 1, which is a schematic diagram of a seat adjustment system 10 according to an embodiment of the present invention. As shown in FIG. 1, the seat adjustment system 10 is utilized for a vehicle seat, and includes a seat body 100, at least one actuating unit 102, a control unit 104, and a sensing unit 106. The at least one actuating unit 102 adjusts support of the seat body 100. The sensing unit 106 obtains and provides seat information and body data of an occupant. The control unit 104 receives data sensed by the sensing unit 106 or an information system, and controls the at least one actuating unit 102 to modify the support of the seat body 100 accordingly through the at least one actuating unit 102. When one parameter of the seat body 100 changes, the control unit 104 makes a portion of the body data of the occupant in a predefined range via the at least one actuating unit 102 (e.g. the control unit 104 send a plurality of control signal to adjust parameters of the at least one actuating unit 102), wherein a portion of the body data of the occupant is corresponding to occupant body part selected from a group consisting of a back, a waist, legs, eyes, a head of the occupant, and the pre-defined range keeps a similar relation between the seat body and the portion of occupant body. For example, when the seat body 100 moves from a first tilt angle to a second tilt angle (i.e. one parameter of the seat body changes the angles of seat back, and a tilt angle may be sensed by the sensing unit 106 via an accelerator or a rotation motor of the seat body 100), the control unit 104 maintains the body shape data of the back of the occupant in a predefined range in the second tilt angle and the first tilt angle, e.g. the at least one actuating unit 102 in the second tilt angle are mapped, and a mapping relationship has a corresponding relationship with body shape parameters of the occupant, where the predefined range can keep the shape of occupant’s back identical. Besides, the at least one actuating unit 102 may further adjust rearview mirrors, steering wheel depth, wind direction of air conditioning outlet when the seat body 100 moves from the first tilt angle to the second tilt angle. Noticeable, the at least one actuating unit 102 is selected from a group consisting of a bladder, a motor unit, a seat shoulder support, a lumbar support, a side wing support, a headrest position, a leg support, a cushion hardness and a seat height. The sensing unit 106 is selected from a group consisting of an airflow sensor, a pressure sensor, an occupant detection sensor, an accelerometer, a piezoelectric sensor, an electrocardiogram sensor, a pulse oximetry sensor, a galvanic skin response sensor, a millimeter wave radar, an infrared sensor, a thermal sensor, a ballistocardiograph sensor, a seat belt tension sensor, an input interface for input, a camera for detection, a seat parameter adjustment sensor, and a vehicle information system, such as a brake sensor, a throttle sensor, a steering wheel adjustment sensor, a car start time sensor, a car speed sensor. As a result, when one parameter of the seat body 100 changes (e.g. a seat angle changes) differently, some supporting parts are automatically adjusted to corresponding positions so that the seat body 100 may keep the support for the occupant.

Specifically, please refer to FIG. 2, which is a schematic diagram of operations of the seat adjustment system shown in FIG. 1 according to an embodiment of the present invention. In the left side of FIG. 2, a seat body is adjusted to the most suitable position first (i.e. the back of the occupant in a dotted line matches the supporting curvature of the seat body in a solid line). Then, the seat body reclines by 30 degrees (e.g. from a sitting mode to a stretching mode). Due to different rotation axis between the seat body and the occupant, the seat body will obviously force to the human spine (i.e. the back of the occupant in a dotted line does not match the supporting curvature of the seat body in a solid line as shown in the right side of FIG. 2). If the occupant leans back 18 degrees and the seat body leans back 30 degrees, the occupant will obtain a better support effect on a waist part, but the occupant’s shoulder is obviously not supported.

In the embodiment of the present invention, the seat adjustment system 10 includes the at least one actuating unit 102 and parameters of the at least one actuating unit 102 are linked with a mapping function with a corresponding relationship with body shape parameters of the occupant, so that corresponding parts of the occupant maintain similar supporting status. The at least one actuating unit 102 may include a valve motivated bladder or a motor controlled mechanical unit to adjust the support of the seat body 100. The sensing unit 106 may include a pressure sensor to provide information of the body shape data of the back of the occupant to the control unit 104 to estimate a range of body parameters of the occupant for modifying the mapping relationship of the at least one actuating unit 102. Therefore, the body shape data of the back of the occupant can be identical when the occupant leans back and is supported by the modified support of the seat body 100, so that the seat body 100 fits the back of the occupant well. In other words, parameters of the at least one actuating unit 102 are linked changed, and the seat body 100 maintains a similar supporting status for corresponding parts of the occupant.

The support of the seat body 100 may also be adjusted to conform to a posture of the occupant according to a status of the seat body 100. The seat adjustment system 10 may also include an input interface for inputting a user-defined curvature, body type, and support degree (softness or hardness) of the seat body 100.

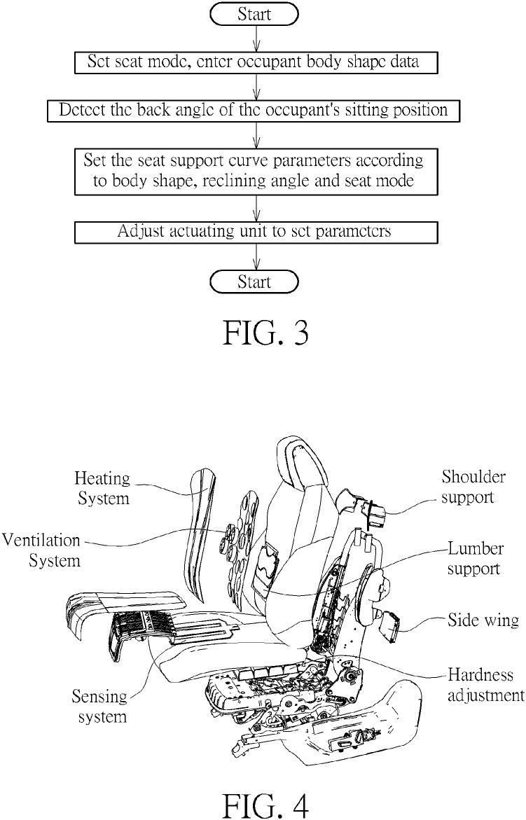

As shown in FIG. 3, the occupant first sets a seat mode to determine whether to perform adjustment, enters the body shape data of the occupant via an input interface, and sets a seat tilt angle. After setting the curve parameters of the seat body 100 according to the body shape data and the reclining angle, the control unit 104 adjusts the at least one actuating unit 102 to a set parameters, which is derived from a built-in correspondence table or built-in function, wherein the body shape data is obtained by comparing the pressure data of the pressure sensor of the sensing unit 106 and the built-in data by the control unit 104 (or inputted via an input interface or detected by a camera). Afterwards, the control unit 104 adjusts the at least one actuating unit 102 by the body shape data. As a result, the present invention performs adjustment according to the body shape data, thereby allowing different occupants to have the same experience as much as possible to achieve a more comfortable and healthy seating experience.

Please refer to FIG. 4, which is an exploded view of the seat adjustment system 10 shown in FIG. 1. In some embodiments, the sensing unit 106 also senses a sitting posture of the occupant, such that the second parameters of the at least one actuating unit 102 in the second tilt angle and the first parameters of the at least one actuating unit 102 in the first tilt angle form a morphism to keep a similar supporting status to maintain the body shape data of the back of the occupant identical according to the body shape data and the sitting posture of the occupant.

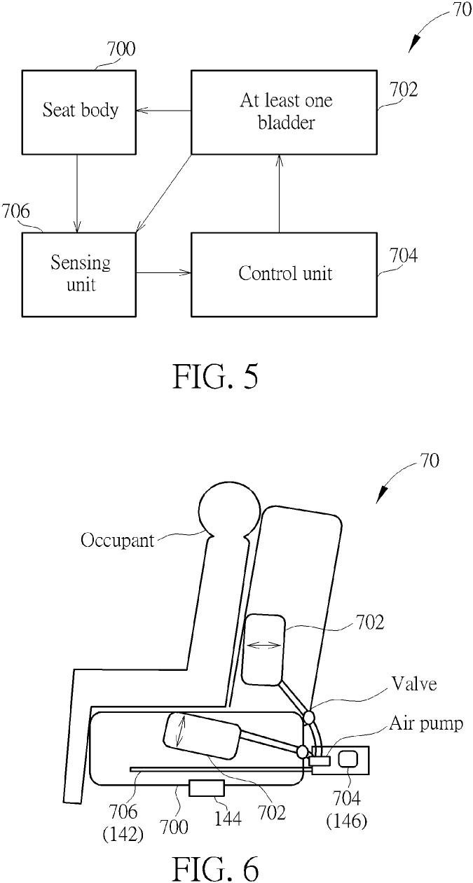

Moreover, to reduce fatigue of the occupant, the support of the seat body may not be fixed and may change in response to time, states of the occupant or environment. As shown in FIG. 5 and FIG. 6, the seat adjustment system includes a seat body 700, at least one bladder 702 (i.e. actuating unit), a control unit 704, and a sensing unit 706. The at least one bladder 702 is inside the seat body 700 and provides support for the seat body 700. The sensing unit 706 obtains and provides a parameter of the seat body 700. The control unit 704 adjusts inflation and deflation of the at least one bladder 702 to change with time according to preset parameters (i.e. the control unit 704 further controls the at least one actuating unit so that the portion of body data of occupant changes around the pre-define range periodically). To avoid disturbing the occupant, the seat support change does not exceed 10%. In addition, a seat state (i.e. a parameter of the seat body) can also be detected in a simplified way. For example, the sensing unit 706 detects a starting time of the vehicle to activate the adjustment. When the starting time of the vehicle exceeds a threshold, such as ten minutes, the seat support changing is activated before the occupant feels fatigue and avoids forgets to turn on the adjustment.

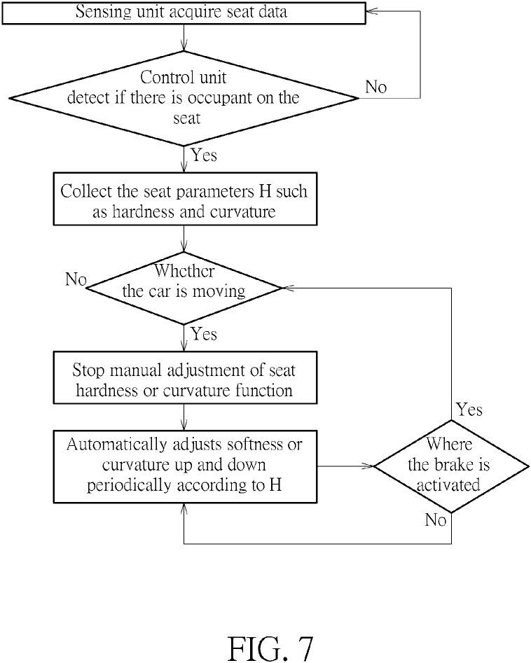

One parameter of the seat body 700 changes is selected from a group consisting of absence of an object on the seat body 700, presence of an occupant on the seat body 700, physiological state of an occupant, and sensed pressure on the seat body 700 due to the occupant contact position, a contact range, a contact time, or a dynamic change. As shown in FIG. 7, the sensing unit 706 acquires the parameter and then the control unit 704 uses the parameter to detect whether there is an occupant on the seat body 700. If yes, the control unit 704 collects seat parameters H such as hardness and curvature. Then, if the vehicle is moving, the control unit 704 automatically adjusts softness or curvature periodically according to the seat parameters H and the manual adjustment of the seat should be stopped until the vehicle stops.

In some embodiments, the control unit 704 controls the at least one bladder 702 inflation and deflation according to a time-varying sequence so that the portion of body data of occupant changes around the pre-define range periodically. When the control unit 704 receives a signal indicating that the change of the brake exceeds a predetermined range or vehicle speed is less than a certain range (i.e. idle or at a low speed), a time-varying sequence of a seat surface by the at least one bladder 702 can temporarily stop. As a result, the occupant may not notice the adjustment when the occupant is not focusing on driving (e.g. idle, at a low speed or in an automatic driving mode), to increase comfort.

Since the present invention modify adjustment in response to states of the occupant, detection of states of the occupant are required. Please continue to refer to FIG. 6, a seat sensing system includes a sensing unit and a computer system 146. The sensing unit further includes a first sensor 142 and a second sensor 144. The first sensor 142 obtains at least one physiological signal of an occupant by contacting with any part of the occupant. The first sensor 142 is selected from the group consisting of a pressure sensor, an accelerometer, a piezoelectric sensor, an electrocardiogram sensor, a photoplethysmogram sensor, sensor, a pulse oximetry sensor, a galvanic skin response sensor, a millimeter wave radar, a camera, an infrared sensor, a thermal sensor, and a ballistocardiograph sensor. The first sensor 142 may also obtain environmental signals from a seat contacted with the occupant, including vibration signals caused by the engine, air conditioner, the occupant’s movements and vibrations from the road surface when vehicle is moving. Those vibration lower the reliability of the occupant’s physiological signal.

The second sensor 144 obtains the environmental signal (that does not contain the physiological signal of the occupant) from the seat and does not obtain the physiological signal of the occupant. The second sensor is selected from the group consisting of a pressure sensor, a rangefinder, an accelerometer, a magnetometer, a gyroscope, a camera, and a gravity sensor. The physiological signal from the first sensor 142 and the environmental signal from the second sensor 144 are collected by the computer system 146 for processing to calculate a signal reliability of physiological information (obtain vehicle environment and signal reliability via feature extraction, spectrum subtraction, and correlation analysis).

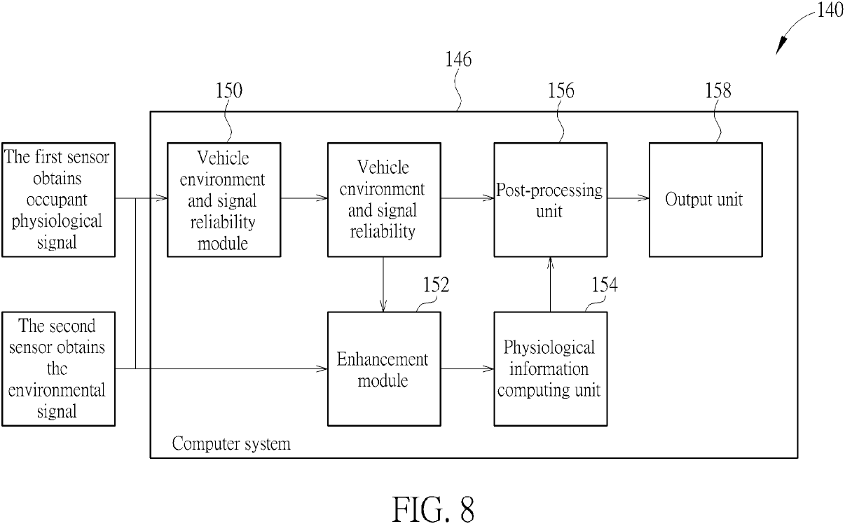

In detail, please refer to FIG. 8, which is a schematic diagram of operations of an occupant sensing system 140 according to an embodiment of the present invention. The physiological signal from the first sensor 142 and the environmental signal from the second sensor 144 are first computed by a vehicle environment and signal reliability module 150, to get signal reliability. Then, enhancement module 152 computes physiological information of the occupant according to signal reliability. A post-processing unit 156 evaluates the physiological information with signal reliability and transmits to an output unit 158 (for just updating the reliable physiological information). The physiological information of the occupant s selected from the group consisting of the occupant’s breath, heart rate, body type, body pressure, blood pressure, spine compression, and fatigue degree.

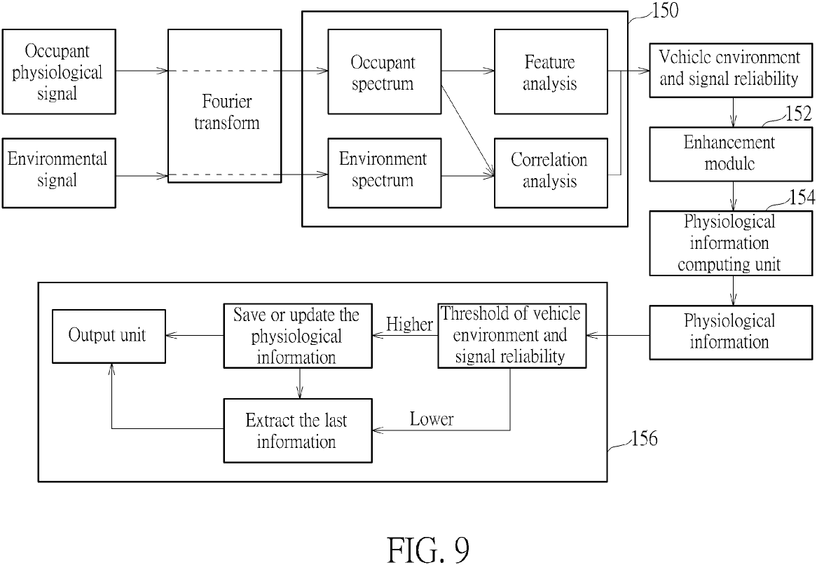

Please refer to FIG. 9, which is a schematic diagram of operations of the computer system 146 according to an embodiment of the present invention. First, feature projection, such as the Fourier transformation is performed. The occupant spectrum is used for feature analysis such as pattern match and signal-to-noise ratio analysis to evaluate signal quality. Then, a set of decision trees is used to determine the vehicle environment and signal reliability.

For example, the vehicle environment is selected from a group consist of stationary, idling, smooth traveling, bumpy traveling, high speed driving, or low speed driving. Noise from environmental is low when stationary or idle, and thus a correlation between the occupant spectrum and the environment spectrum is low, such that vehicle environment and signal reliability is high. On the other hand, when driving, a correlation between the occupant spectrum and the environment spectrum are high, such that the vehicle environment and signal reliability is low.

After the signal evaluation by evaluating the physiological signal of the occupant from the first sensor 142 with the vehicle environment and signal reliability, the signal enhancement module 152 would enhance the physiological signal (or spectrum) with low reliability. When the vehicle environment and signal reliability is higher than the threshold (indicating stationary or idling, and the physiological information of the occupant is reliable), the enhancement module would be ended and enters the physiological information computing unit 154. Otherwise, the enhanced signal will enter a filter for subtracting the occupant signal with the environmental signal is passed to calculate the physiological information.

The purpose of the post-processing unit 156 is to further utilize the vehicle environment and signal reliability, and keep completely unreliable states from continuous recording of physiological information and avoiding erroneous information with a large gap. For example, please refer to the same FIG. 19, the post-processing unit 156 includes a temporary memory. When the vehicle environment and signal reliability is greater than the threshold, the post-processing unit 156 saves or updates the physiological information at a temporary memory. Otherwise, when the vehicle environment and signal reliability is lower than the threshold, the physiological information will be discarded (or not generated by the physiological information computing unit 154 in the first place) and a last physiological information extracted in the temporary memory would be passed to the output unit 158 as the occupant physiological information at this moment.

The physiological information is selected from the group consisting of a portion of respiration, heart rate, body shape, body pressure, blood pressure, and spine shape. The physiological information can as an input of a seat comfort system, a drunk driving detection system, a fatigue reminder, automatic driving, fatigue reminders, and massage system activation, and the seat adjustment system 10. The computer system is further configured to perform a predetermined action by the reliability of physiological information. The seat sensing system further comprises an output unit for signaling part of computational results of the computer system, e.g., the processed physiological signal (or spectrum), vehicle environment and the signal reliability of physiological information. In some embodiments, the output unit could further update its results according to the signal reliability of physiological information, where the output unit is selected from a group consist of at least one actuating unit, a display unit, vibration unit, a speaker, a communication system, an output unit of vehicle information system, a light, and a memory. Moreover, the output unit is configured to adjust support of the seat body.

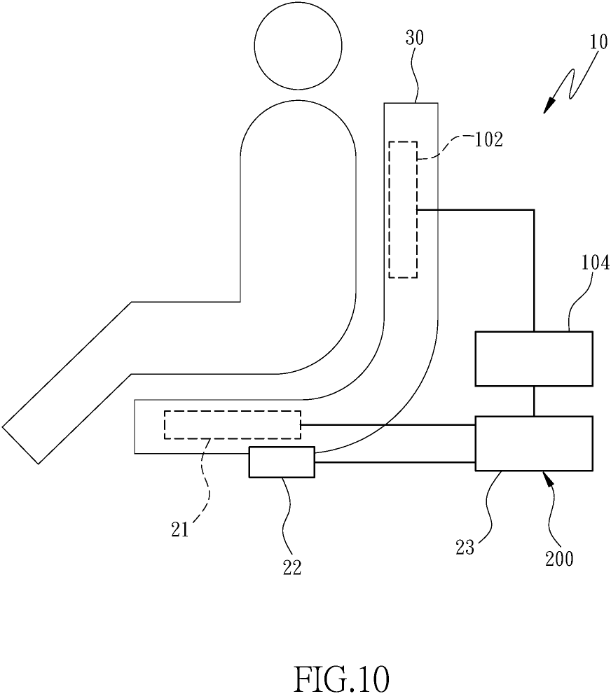

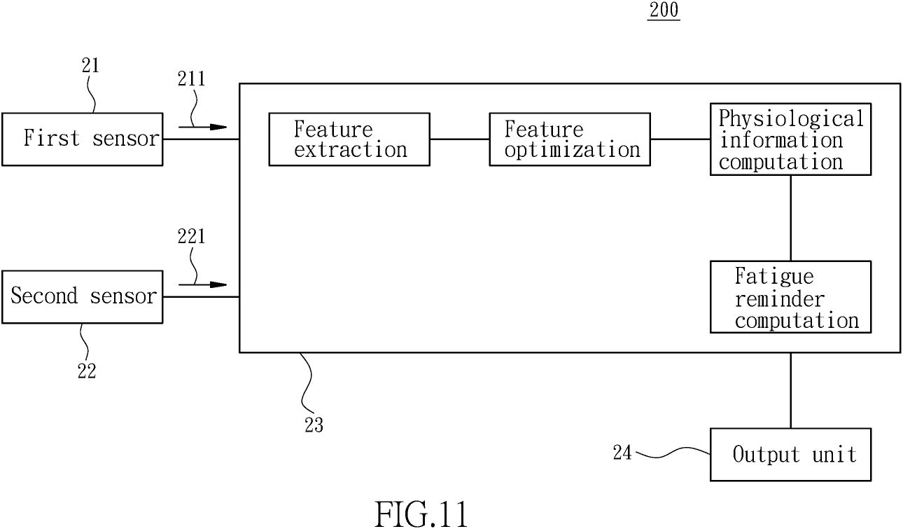

Referring to FIG. 10 and FIG. 11, which are schematic diagrams of an implementation of an occupant sensing system 200 according to an embodiment of the present invention. The occupant sensing system 200 for a vehicle seat 30 includes at least one first sensor 21, at least one second sensor 22, and a computer system 23. Although different reference signs are used for components in this embodiment, reference can still be made to the foregoing embodiment in the detailed description of the components. The at least one first sensor 21 and the at least one second sensor 22 are provided on the vehicle seat 30, where the at least one first sensor 21 obtains at least one physiological signal 211 of an occupant, and the at least one second sensor 22 obtains at least one environmental signal 221 that does not contain the at least one physiological signal 211 of the occupant. The computer system 23 is connected to the at least one first sensor 21 and the at least one second sensor 22, and the computer system 23 receives the at least one physiological signal 211 and the at least one environmental signal 221. The computer system 23 performs a fatigue reminder computation through a computation program of a memory. In some embodiments, the computation program is defined and generated in a program language based on a computation basic model. An environmental auxiliary parameter, generated by performing a feature extraction of the at least one physiological signal 211 and the at least one environmental signal 221, is considered in the fatigue reminder computation by the computer system 23. In this embodiment, the environmental auxiliary parameter is used to solve and mitigate interference (referred to as noise) generated by a vehicle environment, and the environmental auxiliary parameter is considered in a plurality of programs of the fatigue reminder computation. The environmental auxiliary parameter represents a current vehicle state, facilitating fine adjustment of the computer system 23 in the plurality of programs of the fatigue reminder computation, and making the fatigue reminder computation result more accurate. For example, whether the vehicle is started or standstill is determined based on an intensity of the at least one environmental signal 221, when the signal indicates that a total intensity of vibration is higher than a threshold value, the vehicle is deemed as started. For example, whether the vehicle is moving is determined based on comparing another threshold value and a distribution index in a frequency domain of the at least one environmental signal 221, wherein the distribution index is calculated from a ratio of a standard deviation or a maximum peak value to a feature average. The distribution index is greater than the aforementioned threshold if the vehicle only starts without running and is only with engine idle vibrations.

Furthermore, the computer system 23 compares the at least one environmental signal 221 with the at least one physiological signal 211 to obtain a feature correlation between the at least one environmental signal 221 and the at least one physiological signal 211. If the correlation between the at least one physiological signal 221 and the at least one physiological signal 211 is significant, then the physiological signal 211 is deemed as sourced from the occupant and the vehicle environment, and the at least one physiological signal 211 is subsequently used to determine a physiological state. Otherwise, the current at least one physiological signal 211 is discarded due to reliability thereof is low. Accordingly, following environmental conditions are recognized using the environmental auxiliary parameter: “the vehicle moving without occupants” and “the significant body movement of the occupant”, thereby recognizing unusable signals under the environmental conditions and increasing the reliability of subsequent computation results.

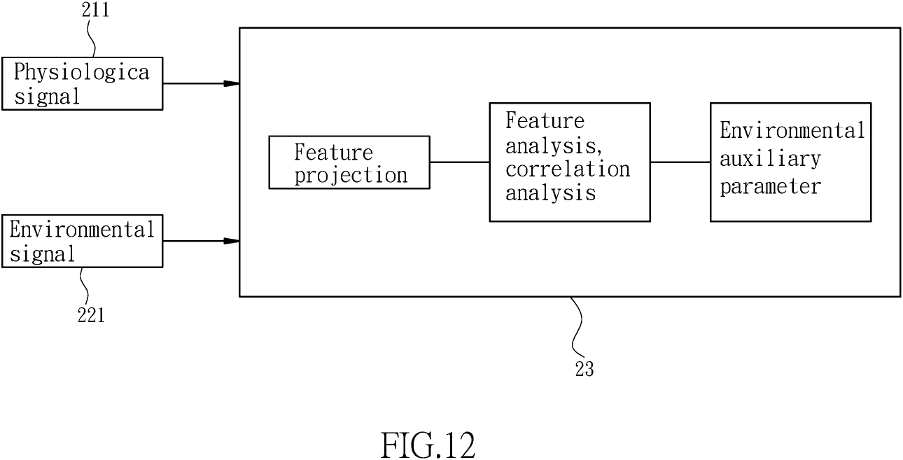

With reference to FIG. 12, a computer system according to an embodiment of the present invention is shown. The computer system 23 generates the environmental auxiliary parameter through performing a feature projection, a feature analysis, a correlation analysis of the at least one physiological signal 211 and the at least one environmental signal 221. The above-mentioned feature projection reduces differences between feature intensity of the at least one physiological signal 211 and feature intensity of the at least one environmental signal 221, so as to solve the problem that large feature difference between the two signals 211 and 221 covers feature of the at least one physiological signal 211 under the original signal coordinate.

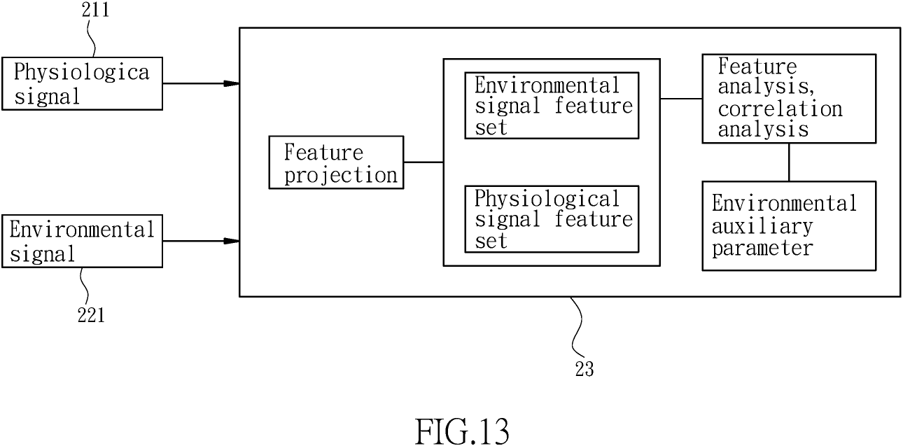

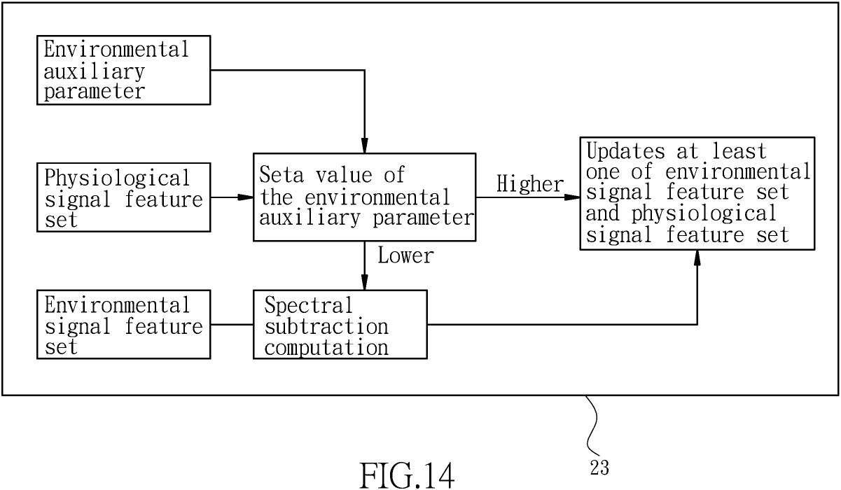

Referring to FIG. 13, in some embodiments, the computer system 23 generates an environmental signal feature set and a physiological signal feature set when the feature projection ends, and each of the environmental signal feature set and the physiological signal feature set is a frequency spectrum. The aforementioned feature analysis and correlation analysis are based on the environmental signal feature set and the physiological signal feature set. Referring to FIG. 14, in an embodiment, the computer system 23 determines whether to perform a feature optimization program through an analysis between the environmental auxiliary parameter and the physiological signal feature set, and the feature optimization program updates at least one of the environmental signal feature set and the physiological signal feature set. The feature optimization program compares to a value of the environmental auxiliary parameter, when the physiological signal feature set is higher than the current environmental auxiliary parameter, the feature optimization program directly updates at least one of the physiological signal feature set and the environmental signal feature set as a computation result of a current signal. When the physiological signal feature set is lower than the current environmental auxiliary parameter, the computer system 23 performs a spectral subtraction computation to update the physiological signal feature set as a result of the spectral subtraction computation.

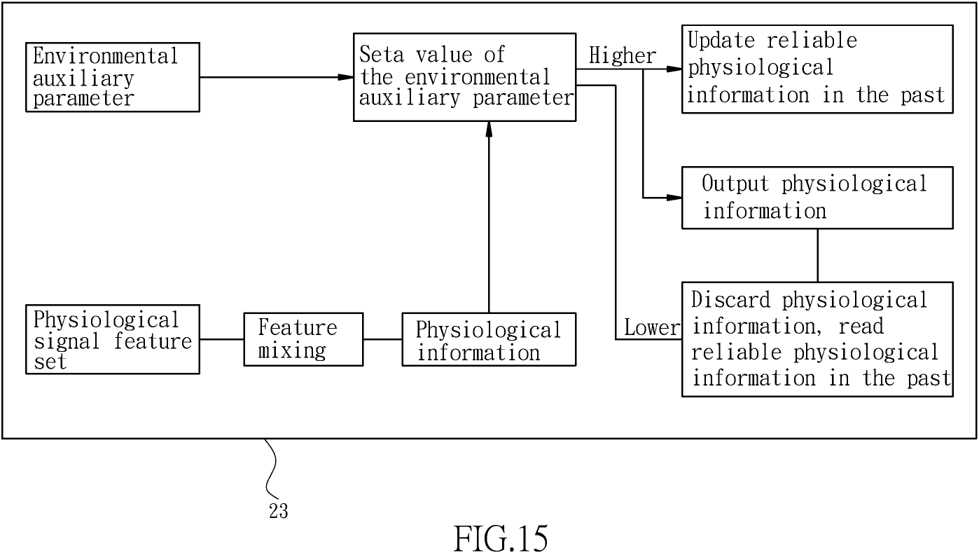

Referring to FIG. 15, the computer system 23 generates a physiological information through performing feature mixing of the physiological signal feature set, and the environmental auxiliary parameter is used to determine the reliability of the physiological information. The at least one physiological signal 211 includes a main feature and at least one derived feature, where the derived feature has a lower probability of being interfered by the vehicle environment. The physiological information including a new feature generated through a mixing computation of the at least one derived feature and the main feature included in the at least one physiological signal 211, and then the physiological information is used in the fatigue reminder computation. The physiological information is a heart rate, or a heart rate variability, etc. In some embodiments, the mixing computation performs superposition of harmonic frequencies on the physiological signal feature set. When the environmental auxiliary parameter is used to determine reliability of the physiological information, if the determination result is higher than a value set for the environmental auxiliary parameter, then the reliable physiological information in the past is updated and the physiological information is output. However, if the determination result is lower than the value set for the environmental auxiliary parameter, the current physiological information is discarded, and the aforementioned reliable physiological information in the past is read.

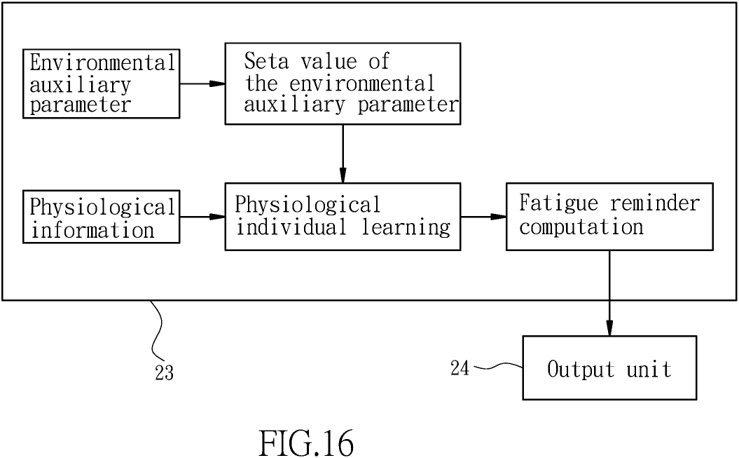

With reference to FIG. 16, in an embodiment, the computer system 23 performs a physiological individual learning based on the at least one physiological information generated at different times to smooth out computational errors caused by individual differences. The aforementioned different moments are moments when the vehicle is idling, or other situations that are designated for inclusion in the learning. In some embodiments, the environmental ancillary parameter is considered in the physiological individual learning.

Referring to FIG. 11, the occupant sensing system 200 further includes at least one output unit 24 connected to the computer system 23 to operate based on the result of the fatigue reminder computation. The at least one output unit 24 is as previously described and is not detailed herein. When the occupant sensing system 200 is applied to the seat adjustment system 10 described above, the occupant sensing system 200 is connected to the control unit 104 to control the at least one actuating unit 102 based on the result of the fatigue reminder computation.

Noticeably, each unit of the control units 104 and 704, the computer system 146, and the computer system 23 described above may include a processor and a memory. The memory is configured to store a program code to instruct the processor to achieve respective functions. The memory may be a non-volatile memory (NVM), e.g., an electrically erasable programmable read only memory (EEPROM) or a flash memory, and not limited thereto. The processor may be a digital signal processor (DSP) or a central processing unit (CPU), and not limited thereto.

To sum up, the present invention provides an occupant with more comfortable and healthy seating experience and assisting the occupant to control a vehicle to achieve better safety protection and user experience.

What is claimed is:

1. An occupant sensing system for a vehicle seat, comprising:
at least one first sensor, disposed in the vehicle seat to obtain at least one physiological signal of an occupant;
at least one second sensor, disposed in the vehicle seat to obtain at least one environmental signal that does not contain the at least one physiological signal of the occupant; and
a computer system, connected to the at least one first sensor and the at least one second sensor, the computer system receiving the at least one physiological signal and the at least one environmental signal, and an environmental auxiliary parameter, generated by performing a feature extraction of the at least one physiological signal and the at least one environmental signal, is considered in a fatigue reminder computation by the computer system.

2. The occupant sensing system according to claim 1, wherein the computer system generates the environmental auxiliary parameter through performing a feature projection, a feature analysis, and a correlation analysis of the at least one physiological signal and the at least one environmental signal.

3. The occupant sensing system according to claim 2, wherein the computer system generates an environmental signal feature set and a physiological signal feature set when the feature projection ends, the environmental signal feature set and the physiological signal feature set are considered in the feature analysis and the correlation analysis.

4. The occupant sensing system according to claim 3, wherein the computer system determines whether to perform a feature optimization program through computing an analysis between the environmental auxiliary parameter and the physiological signal feature set, the feature optimization program updating at least one of the environmental signal feature set and the physiological signal feature set.

5. The occupant sensing system according to claim 4, wherein the computer system generates at least one physiological information through performing a feature mixing of the physiological signal feature set, and the environmental auxiliary parameter is used to determine a reliability of the at least one physiological information.

6. The occupant sensing system according to claim 5, wherein the computer system performs a physiological individual learning based on the at least one physiological information generated at different times, and results of the physiological individual learning are added to the fatigue reminder computation.

7. The occupant sensing system according to claim 3, wherein the computer system generates at least one physiological information through performing a feature mixing of the physiological signal feature set, and the environmental auxiliary parameter is used to determine a reliability of the at least one physiological information.

8. The occupant sensing system according to claim 4, wherein the occupant sensing system further comprises at least one output unit connected to the computer system to operate based on results of the fatigue reminder computation.

9. A seat adjustment system, comprising:
a seat body;
an occupant sensing system, according to claim 1;
at least one actuating unit, adjusting support of the seat body; and
a control unit, connected to the occupant sensing system and the at least one actuating unit, the control unit controlling the at least one actuating unit based on a fatigue reminder computation performed by the occupant sensing system.
